(19) United States
(12) Patent Application Publication
(10) Pub. No.: US 2016/0178307 A1
(43) Pub. Date: Jun. 23, 2016

(54) HOIST DEVICE WITH SHOOTING AID

(71) Applicant: William JOHNSON, Mt. Laurel, NJ (US)

(72) Inventor: William JOHNSON, Mt. Laurel, NJ (US)

(21) Appl. No.: 14/576,700

(22) Filed: Dec. 19, 2014

(51) Int. Cl. F41A 23/02; B66D 3/00

(52) U.S. Cl. CPC F41A 23/02; B66D 3/00

(57) ABSTRACT

A gear hoist and shooting aid combination includes a bag to store a line used for hoisting of items or gear to an elevated structure. The ends of the line are fixed when the line is stored in the bag to prevent tangling of the line during storage. The line includes a shooting aid, which can be sized and positioned to steady a person's body part to assist in aiming and shooting at game animals and optionally a treestand support to ease installation of the treestand in a desired location.

### FIELD OF THE INVENTION

The present invention is directed to a hoist device that employs a shooting aid to facilitate lifting of hunting gear to an elevated location like a hunting stand. The gear hoist doubles as a shooting aid for a hunter in a tree stand.

### BACKGROUND ART

In the sport of hunting, the use of tree stands is commonplace. One issue with a tree stand is the need to lift hunting gear to the tree stand. Various devices have been proposed to accomplish this task, see for example U.S. Pat. No. 7,118,095 and a hoist offered by Big Game Tree Stands called the Magna Lift, see http://www.midwayusa.com/product/860036/big-game-magna-lift-treestand-gear-lift-rope-30, to offer a tangle free hoist.

The hunting industry also offers a number of different devices to assist a hunter when shooting a game, including various types of supports like tripod, monopods, shooting rests and the like.

However, there is still a need to provide effective ways to raise or hoist gear or other items to an elevated location as well as provide improvements in the aids provided for hunters or others when shooting a weapon. The present invention responds to these needs with an improved gear hoist and shooting aid device.

### SUMMARY OF THE INVENTION

A first object of the present invention is to provide a gear hoist and shooting aid device.

Another object of the invention is a method of using the gear hoist and shooting aid device. Other objects and advantages of the present invention will become apparent as the description thereof proceeds.

The invention is an improvement over known gear hoists and shooting aids. In one mode, inventive gear hoist and shooting aid comprises a bag or other container, (hereinafter bag) and a length of line. One end of the line is secured to an inside of the bag with the other end of the line having a configuration that allows the end of the line to be secured to the bag, e.g., a hook or clip, which then can be used to lift gear once the bag is attached to the elevated structure. In this way, both ends of the line are fixed and the line cannot get tangled when stored in the bag.

The shooting aid can include a loop or just a length of line that is movable along the length of the line and, optionally adjustable in length. Once the bag is attached to an elevated structure using an attaching means, the loop or line can provide support for the arm or hand of a shooter. The optional adjustability of the loop/line on the main length and movable position allows for different sized hunters and different shooting positions with respect to the attached bag. The loop can be made using the existing line and a clampable connector or adjuster or a separate length of line, whereas using just a length of line would be in addition to the line intended for gear hoisting. This support can also be just a length of line attached to the main length where the shooter simply holds this length or wraps it around their hand for adjustments.

The bag can be attached to an elevated structure like a tree in any number of ways. A simple hook or loop could be used in conjunction with some part of the elevated structure to attach to. Another way that merely encircles the elevated structure uses a length of line that extends from the bag, preferably a closed end of the bag. This length of line is attached to a portion of the line that can be stored in the bag using a connector that forms a loop that allows the connected length of line and line portion to encircle the elevated structure like a tree. Once the bag is secured, the line stored in the bag can be used to hoist gear to the elevated location where the bag is attached, e.g., up in a tree for hunting purposes. The bag can also be attached to what are commonly referred to tree hooks or gear hangers. Additionally, the bag can be attached to the hunter for ease of climbing up the tree.

The hoist and shooting aid device can also employ a means to support a treestand once the bag is secured in its desired position. The means includes a connector arrangement mounted to a portion of the line intended to be stored in the bag. The mounting location is such that once the bag is secured to the tree, the connector arrangement is easily accessible so that it can attach to a part of a treestand and support it independently and without the use of any hands. This allows for a two handed install of the treestand and treestand safety.

The invention also entails a method of hoisting gear to an elevated structure using the hoist once the bag is secured (in position)to the elevated structure. Securing the bag also then provides the opportunity to use the shooting aid when hunting and supporting a treestand for installation.

Another embodiment of the invention is making the bag a part of a garment or other article that would be carried by a bag user. Garments could include pants, jackets, shirts, or virtually any garment capable of having a pocket functioning as the bag for the line for gear hoisting. In this embodiment, there is no need for the shooting aid or any means to attach the pocket to any other structure and the line would primarily be used as a gear hoist.

In yet a further embodiment, the bag and line could be used for tangle free purposes alone rather than to facilitate hoisting gear. For example, the line could be a rope or other elongate material to be sold and used when disconnected from the bag or with the bag still in place. The line could be an extension cord with one end of the extension cord extending through the bag to enable the cord to be used with the bag still retained on the cord. Another embodiment of the invention is the ability to support a treestand with the bag when attached to an elevated structure. The length of line includes an additional connector that allows a treestand to be attached to the line and supported prior to its installation.

### BRIEF DESCRIPTION OF THE DRAWINGS

Reference is now made to the drawings of the invention as described below.

FIG. 1 is a schematic representation of one embodiment of a gear hoist and shooting aid device.

FIG. 2 shows a schematic representation of one mode of attaching the gear hoist to an elevated structure.

FIG. 3 shows the attachment of FIG. 2 in a completed configuration around a tree.

FIG. 4 shows another embodiment of one end of the bag of the gear hoist.

FIG. 5 shows a portion of the shooting aid aspect of the invention in an open or adjustable position.

FIG. 6A shows the portion of FIG. 5 in a clamped configuration.

FIG. 6B shows a variation of the shooting aid of FIGS. 5 and 6A.

FIG. 7 shows an alternative shooting aid configuration.

FIG. 8 shows the shooting aid in an exemplary use.

FIG. 9 shows one embodiment of the attachment of the bag of the gear hoist to an end of the line stored in the bag.

FIG. 10 shows an alternative attachment to that shown in FIG. 9.

FIG. 11 shows an alternative embodiment using the bag of the gear hoist of FIG. 1.

FIG. 12 shows a schematic diagram of the embodiment of FIG. 2 with the additional capability of supporting a treestand.

FIG. 13 shows the embodiment of FIG. 12 in actual use supporting a treestand.

FIG. 14 shows an embodiment of the invention wherein rope is stored in a tangle free manner.

FIG. 15 shows another embodiment of the invention using the gear hoist bag in an alternative way.

FIG. 16 shows an alternative to the shooting aid loop of FIG. 1.

### DESCRIPTION OF THE PREFERRED EMBODIMENTS

The invention is an improvement over known gear hoists and shooting aids. The inventive gear hoist and shooting aid comprises a bag or other container and a length of line. While the container can be any type as described in more detail below, the term “bag” is used to describe the container that holds the length of line.

One end of the line is secured to an inside of the bag with the other end of the line having a configuration that allows the end of the line to be secured to the bag at a location thereon. In this way, both ends of the line are fixed and the line cannot get tangled (or knotted) when stored in the bag.

The bag also has a connector or attaching means that allows the bag to be attached to an elevated structure, a part of a tree, a structure in the tree like a tree stand, etc. This connector could be in the form of a loop, a carabiner, hook, or the like. Virtually any type of a connector can be employed that allows the bag to be supported or held by an elevated structure, or part of the tree.

The line comes in sufficient length so that it can extend from the elevated location, e.g., a tree stand, to ground or near the ground. The length can vary but a typical range would be from 20 to 40 feet. The line can take any form, rope, webbing, chain, cable or the like.

The shooting aid of the inventive device comprises a loop of material, and the loop material could be part of the line or a separate loop of material. The loop of material can be designed to be adjustable in terms of the size of the loop and moveable so that the loop can be positioned in different distances from the bag itself. When the shooting aid is part of the line, a clamping device or adjuster can be provided as explained below.

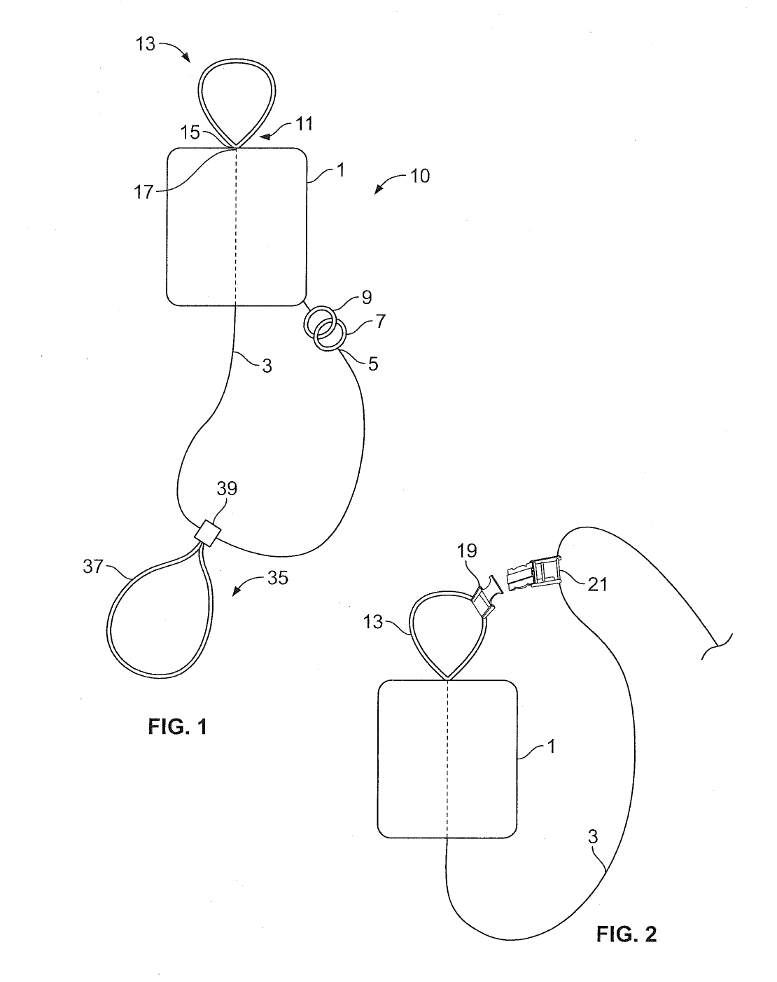

FIG. 1 shows a schematic view of one embodiment of the inventive device, which is designated by the reference numeral 10. The device 10 includes a bag 1 and length of line 3. One end of the line is designated by the reference numeral 5, and this line has a first connector, schematically represented by the loop 7, which can be a clip or the like.

The bag 1 has a second connector, schematically represented by the loop 9. The loops 7 and 9 are shown to be interconnected at 11. This interconnection fixes the end 5 of the line to the bag so that it is not a free end and the line stored in the bag does not tangle.

The bag has an attaching means for attaching the bag to an elevated structure like a part of a tree. This attaching means can be part of the same line stored in the bag or separate therefrom. When using the line 3 to facilitate the attachment of the bag to the elevated structure, the other end of the line 3 is designated by the reference numeral 11. The end 11 can have different configurations. In one configuration, the line 3 could extend through the bag 1 and form the loop 13 shown in FIG. 1. In this embodiment, the free end 15 of the line 3 is secured not only to the bag but also secured to the part of the line that extends through the bag. In this way, the line 3 is secured to the bag to prevent tangling and the same line can be used to facilitate attachment of the bag to the tree.

Other embodiments in this regard could have the line 3 terminate at the point 17 and another and separate length of line could be used to form the loop 13. In any configuration, the end of the line 3 or portion of the line 3 in the bag and opposite the end 5 is fixed to the bag in some manner so that neither end of the line 3 is free to cause a tangle.

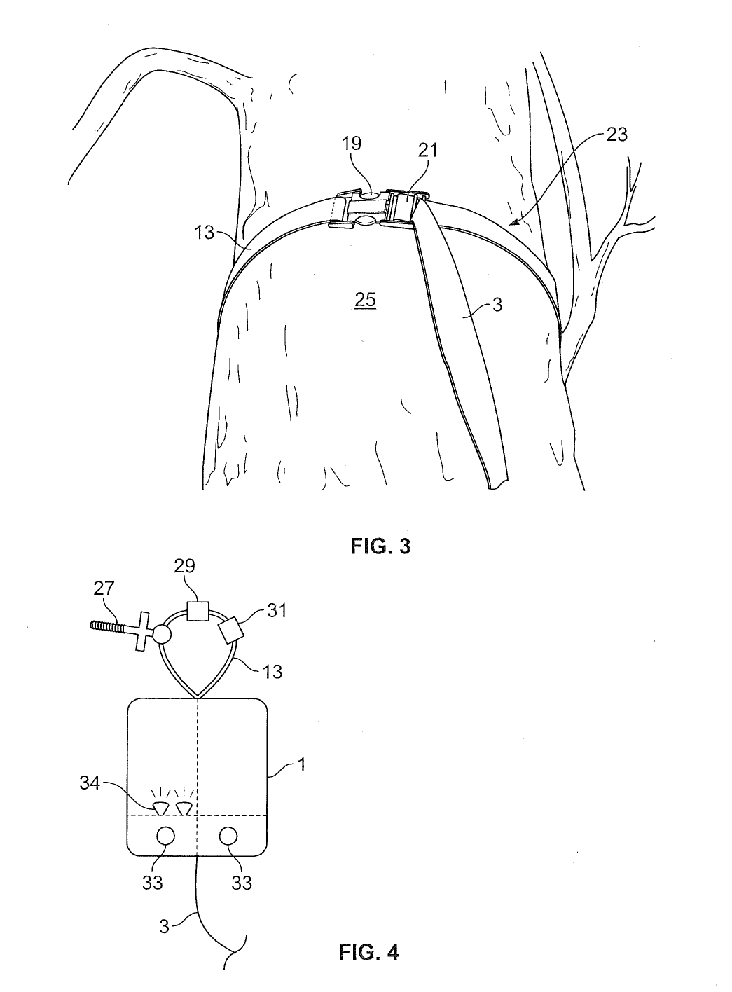

The loop 13 can be used alone to secure the bag 1 to an elevated structure like a part of a tree or a tree stand. However, the loop can be used in combination with other components for attachment to the elevated structure. FIG. 2 shows one embodiment, wherein the loop 13 is provided with a male clip at a fixed or even movable location on the loop 13. The line 3 is provided with a female clip 21, which moves along the line 3 to allow the loop 13 to be changed to accommodate different structures for attachment. It should be noted that the shooting aid of FIG. 1 is not shown in FIG. 2 but would be located on the line 3 that is shown terminated. FIG. 3 shows the clips 19 and 21 connected to form a loop 23, which surrounds the tree 25 so as to secure the bag 1 to the tree 25. The clips 19 and 21 are typical of male and female clips used in backpacks or other gear wherein the male clip sides are squeezed together to release the clip connection. However, any type of connection between the loop 13 and a point along the length of the line 3 can be used to form the new loop 23.

FIG. 4 shows another schematic alternative for loop 13. In this embodiment, the rotatable tee-handled screw 27 could be attached to the loop 13, with screw 27 being able to be screwed into a tree to secure the bag 1. The examples shown in FIGS. 2-4 are just that, only examples, and virtually any type of connection or means for attaching can be employed to secure the bag to the elevated structure. In fact, the line 3 could terminate in the bag 1 and a separate connector not associated with the line could be employed for connection purposes.

The loop 13 or even line 3 could be used to secure other items as well. In FIG. 4, a compass is designated schematically as 29 and could be attached to the loop 13. As a further option, the loop 13 could include a clip designated schematically as 31 to allow the bag to be carried by a person when the line 3 is stored therein. The bag 1 in FIG. 4 is also shown with a closure in the form of a pair of snaps 33. Of course, other types of closures could be employed, zippers, hook and loop fasteners, elastic bands, drawstrings, and the like to keep the line 3 stored in the bag 1 when not in use.

Still referring to FIG. 4, the bag 1 could also incorporate one or more battery-powered lights. A pair of lights 34 are shown attached to the bag 1. Of course, the location of the lights could be anywhere on the bag 1.

Referring back to FIG. 1, a shooting aid is designated by the reference numeral 35. The shooting aid comprises a loop 37 and is designed so that is can move along the length of the line 3 and can be adjustable in size to accommodate different shooting positions and different size shooters. The capability of moving the shooting aid and optionally changing the length of the loop 37 is represented schematically by reference numeral 39 in FIG. 1.

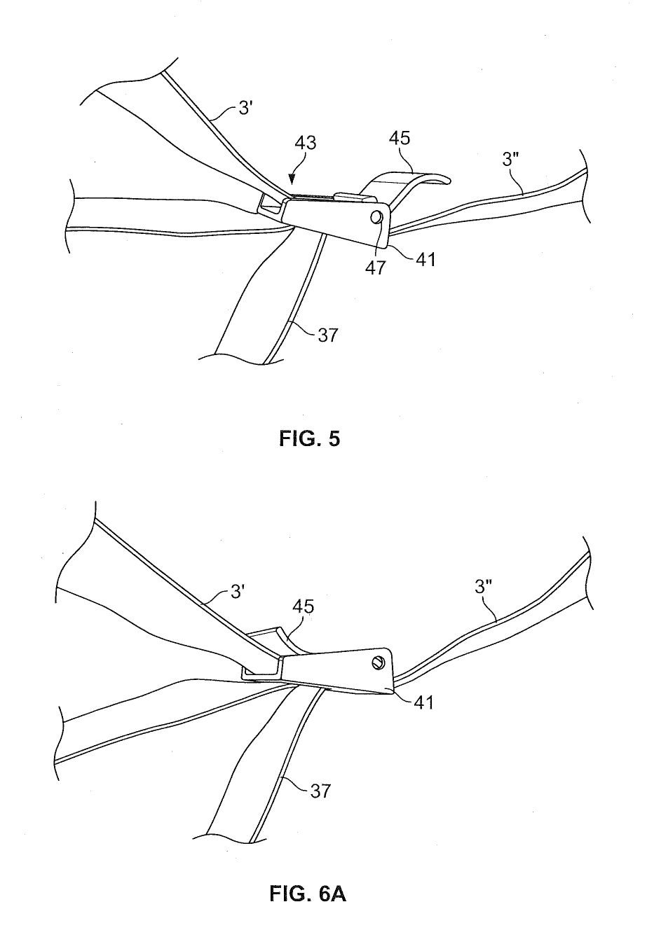

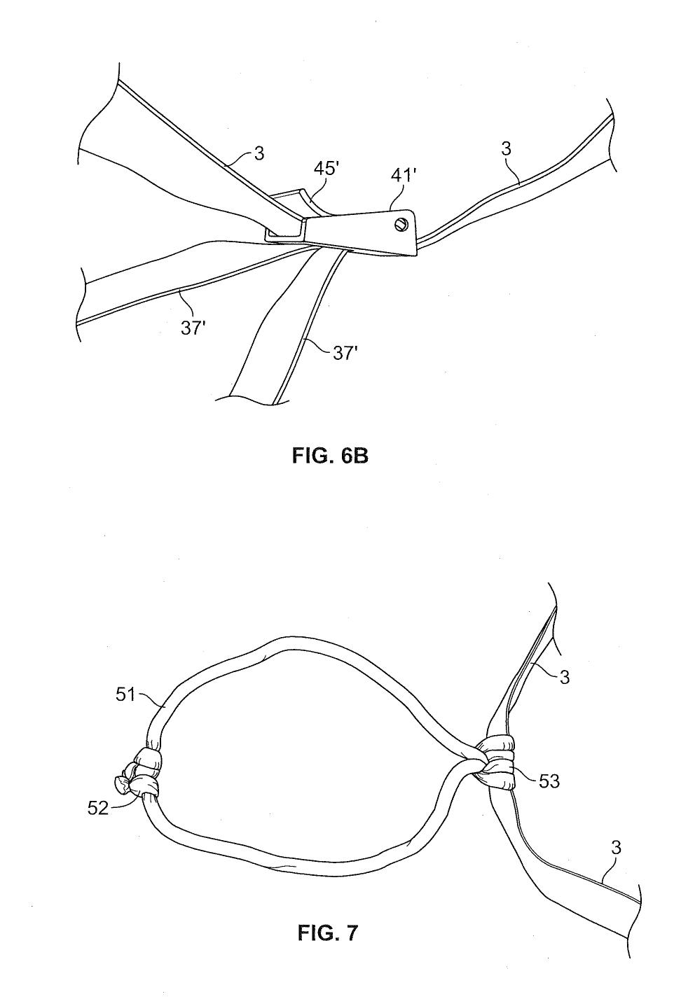

FIGS. 5 and 6A show one embodiment of the shooting aid 35, wherein an adjuster 41 is provided and this embodiment allows for the optional adjustment of the size of the shooting aid 35. The adjuster 41 has basically two passageways to allow the line 3 to pass through and form the loop 37. The first passageway is identified by reference numeral 43, wherein a portion of the line part 3′ goes through the passageway to form the loop 37. The adjuster has clamp 45, which is shown in the open position. A portion (not shown) of the line part 3″ passes between an underside of the clamp and a surface (not shown) of the adjuster 41, the other passageway. The clamp 45 pivots about point 47 and is configured, when in the closed position, see FIG. 6, to clamp down on part of the line part 3″ to prevent it from moving with respect to the adjuster 41.

Since the line 3 is fixed at the elevated structure. i.e., secured to the bag in some way, and the line part 3′ freely passes through the passageway 43 in the adjuster 41, the location of clamping the adjuster on the line part 3″ also determines the length of the loop. There has to be sufficient length from the point of clamping of the adjuster to the end of the line in the bag 1 to allow for both creation of the loop 37 and positioning of the shooting aid for the hunter or other shooter.

FIG. 6B shows an alternative to the embodiment of FIGS. 5 and 6A. The embodiment employs a shooting aid that is not adjustable in size and only permits the shooting aid to move along the length of the line 3. The adjuster 41 is configured differently as compared to FIG. 6A in that the line 3 runs through the adjuster 41′ and the adjuster 41′ is movable along the line 3 and secured at a given position on the line 3 by closing the clamp 45′ at the desired location. A loop 37′ is provided and fixed to the adjuster 41′ so that the loop is of a fixed size.

While the embodiment in FIGS. 5 and 6A uses the line as part of the shooting aid, a separate length of line could also be used while still maintaining the capability of moving the shooting aid and allowing one to select the length of the loop. This embodiment is shown in FIG. 7 and entails the use of a separate loop 51 of rope. The loop 51 could be formed in a continuous way, i.e., no ends, or formed from a length of rope with the ends tied together at 52 as shown in FIG. 7. In either case, the loop can be knotted onto the line 3 by merely wrapping the loop around the line 3 and then inserting a part of the loop through another part to form the knot 53. With this knot, pressure on the loop, e.g., a shooter's arm tightens the knot and secures the loop on the line. Relaxing the knot allows the loop to move along the line 3 to a desired location. The loop length could be altered by tying knots in the loop to shorten the length. In the alternative, loops of different lengths could be provided and a hunter or other shooter could select the loop length that is appropriate for the hunter's size and preferences.

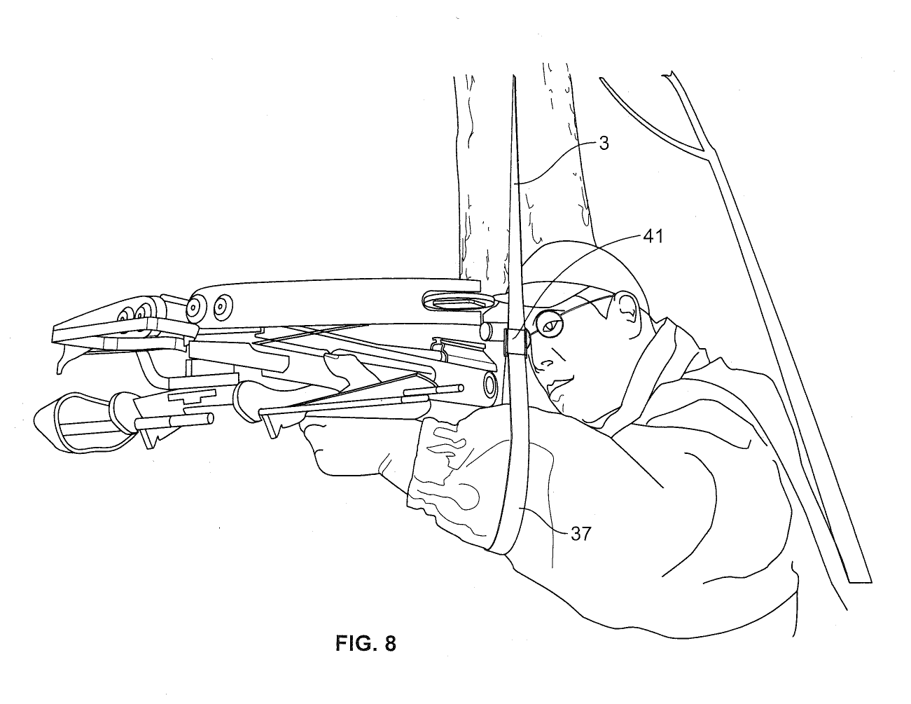

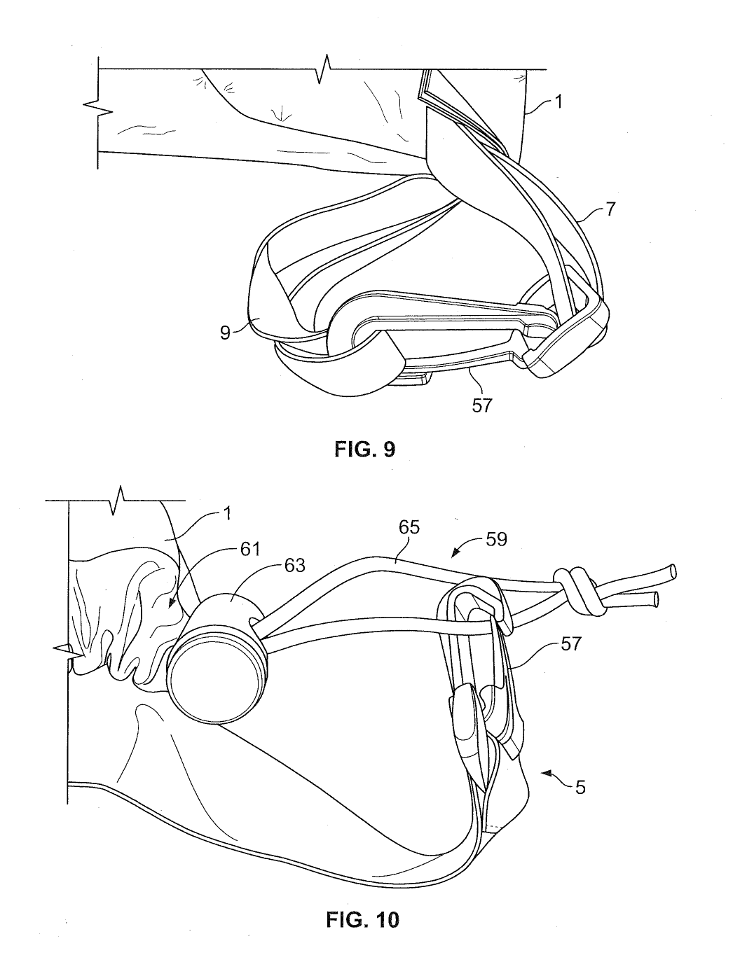

FIG. 8 shows an exemplary use of the shooting aid, wherein a part of a shooter's arm rests in the loop 37.

FIG. 9 shows an embodiment related to how the end 5 of the line 3 is secured to the bag 1. The line 3 ends in a loop 7 and a clip 57 is secured to the loop 7. The clip 57 can then be connected or disconnected to the loop 9 on the bag as the user of the device chooses. Again, connecting the loop 7 of the end 5 of the line 3 means that the line 3 when pulled from the bag 1 will not be tangled. Again, virtually any type of connection can be made between the end of the line 3 and the bag 1 to ensure that the two ends of the line are fixed and tangle free when not in use.

FIG. 10 shows yet another embodiment of the invention relating to the connection between the bag 1 and the end 5 of the line. In this embodiment, the same clip 57 is employed in conjunction with the end 5 of the line 3. However, the clip 57 is attached to a drawstring tie closure 59 for the bag 1. The closure 59 is one that is well known and uses a band that extends in a channel 61 that surrounds the open end of the bag 1. The closure 59 includes a spring-biased locking device 63 and cord 65. The channel 61 of the bag is gathered or compressed to close the opening of the bag and the device 63 maintains the channel 61 in its compressed state. The user only needs to compress the locking device 63 to release the tension on the cord 65 to allow channel 61 to expand and open the bag. In this way, the bag closure 59 already has a loop in the form of the cord 65 to receive the clip 57 and no additional structure is needed for the bag 1.

While FIGS. 9 and 10 shows a means for attaching one end of the line 3 to the bag to assist in preventing tangling, any kind of a connection between the bag and the line end 5 can be employed. The clips used to secure to the tree as shown in FIG. 3 can be employed in place of the clip and loop of FIG. 9 as one example.

Similarly, while snaps are shown as a means for closing the bag 1, any type of closure can be employed to ensure that the line does not readily escape from the confines of the bag 1.

Since the loop 37 of the shooting aid can be made in different sizes in the adjustable embodiment, the loop 37 can be used in other ways. Referring back to FIG. 1, the loop 37 could be made very large so that a game animal that has been shot and needs to be dragged to a different location could be snared by the loop 37. The hunter could then drag the game animal via the bag 1, loop 13, or even just the line 3. For the embodiment of FIG. 6a, wherein the loop is fixed to the adjuster, the loop could be made with two ends and a buckle to allow for loop adjustability. This type of arrangement to link two end of a line is well known and a further description of the details of the buckle is not necessary for understanding of the invention.

While a bag is shown, any type of container, flexible or rigid could be used to store the, line. A rigid container could have a removable lid and the line could extend through the lid or through the container.

While a particular adjuster is shown for the shooting aid for attachment to the line, any device that would allow the strap of the shooting aid to be attached to the line, allow the strap to be adjustable in length, and allow the strap to be moved along the length of the line can be employed.

Referring back to FIG. 1, another aspect of the invention can be just the use of the bag, line, etc. and without the shooting aid. In this embodiment, the line 3 is tangle free and can be used as a gear hoist.

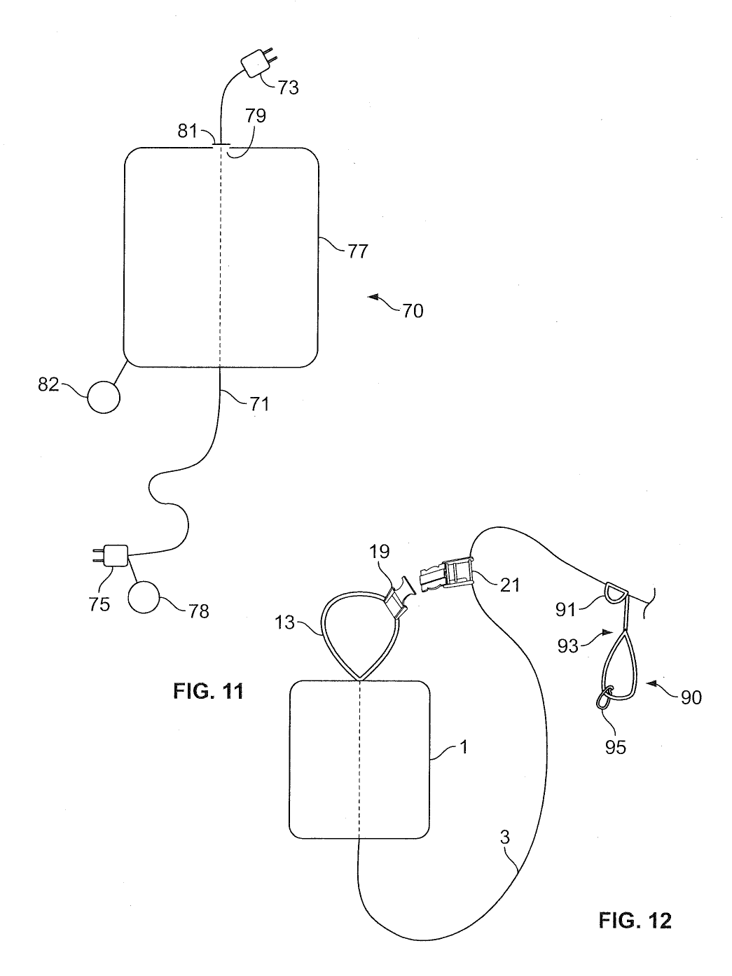

When not using the shooting aid, another embodiment of the line-only mode of the invention is to use an extension cord as the line, see FIG. 11. This embodiment is designated by the reference numeral 70 and includes an extension cord 71 with two plugs 73 and 75. The bag 77 is configured so that the plug 73 could pass an opening 79 in the bag but that the opening could be closed using a connector, schematically represented by 81, e.g., using a hook and loop fastener, snaps, or the like. The closure would prevent the plug 73 from being drawn back through the bag 77 so as to be entangled with any cord in the bag 77.

The other plug 75 would have a connector, represented schematically as 78, the connector designed to interconnect to the connector 82 on the bag 77 to prevent tangling. The options for connectors as disclosed above for the bag and shooting aid combination apply to the embodiment of FIG. 11.

In another aspect of the invention, a plurality of lines could be used in conjunction with the bag 1. One line could function just as a gear hoist and another line could have the shooting aid on it.

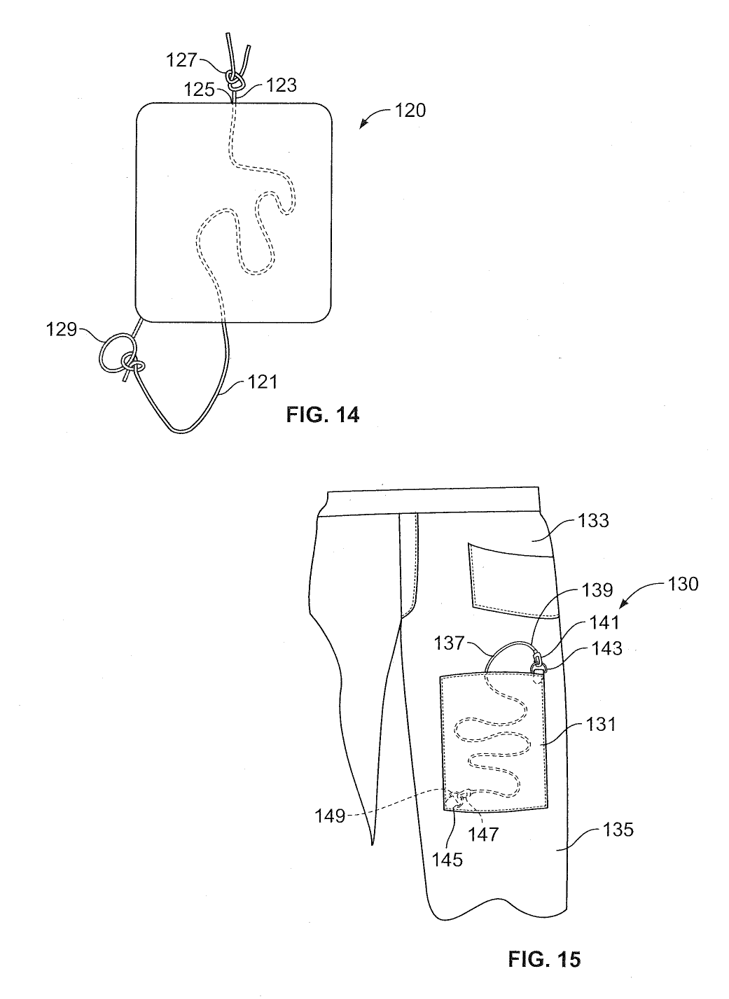

In yet a further aspect of the invention, the bag 1 could be used to store rope while keeping it tangle or knot free. In this embodiment, the arrangement of the rope would be similar to that shown for the extension cord. That is, one end of the rope could be knotted to the connector 82 on the bag, see FIG. 11. The other end of the rope would extend through the bag like the extension cord 71 in FIG. 11. The other end of the rope could be knotted so that it would not pull through the opening in the bag, allowing the rope to have a free end in the bag and tangle. The other end of the rope could also be connected to a connector located on the bag to keep the other end secure and assure tangle free storage. FIG. 14 shows an illustration of this embodiment, designated by the reference numeral 120. A rope 121 is provided, with one end 123 extending through an opening 125 in the bag 120 and knotted at 127 to prevent the rope 120 from slipping back into the inside of the bag and becoming a free end. The other end of the rope 121 is knotted at the clip 129. The rope can be used by untying the knots and removed from the bag or the bag could be left to slide on the rope is so desired. This offers a different packaging method for a rope seller that maintains the rope in a tangle free state. While rope is disclosed, any elongate material could be stored in the bag for sale, e.g., cable, chain, or the like. Multiple lengths of rope or other materials could be packaged together.

Another embodiment of the invention entails the additional of the capability of holding a treestand in place while the device is secured to an elevated structure like a tree. This embodiment relates to the embodiment of FIG. 2, which has the feature that allows the line 3 to be attached around an elevated structure like a tree. It is desirable to support the line 3 in two places to provide the support for the treestand and FIG. 2 shows one embodiment wherein the line 3 extending from within the bag 1 is used to both attach the bag to the elevated structure and provide support for a treestand. Of course, the attachment of the bag 1 alone, e.g., just using the loop 13 in FIG. 1, to an elevated structure in combination with the treestand support feature is also within the scope of the invention.

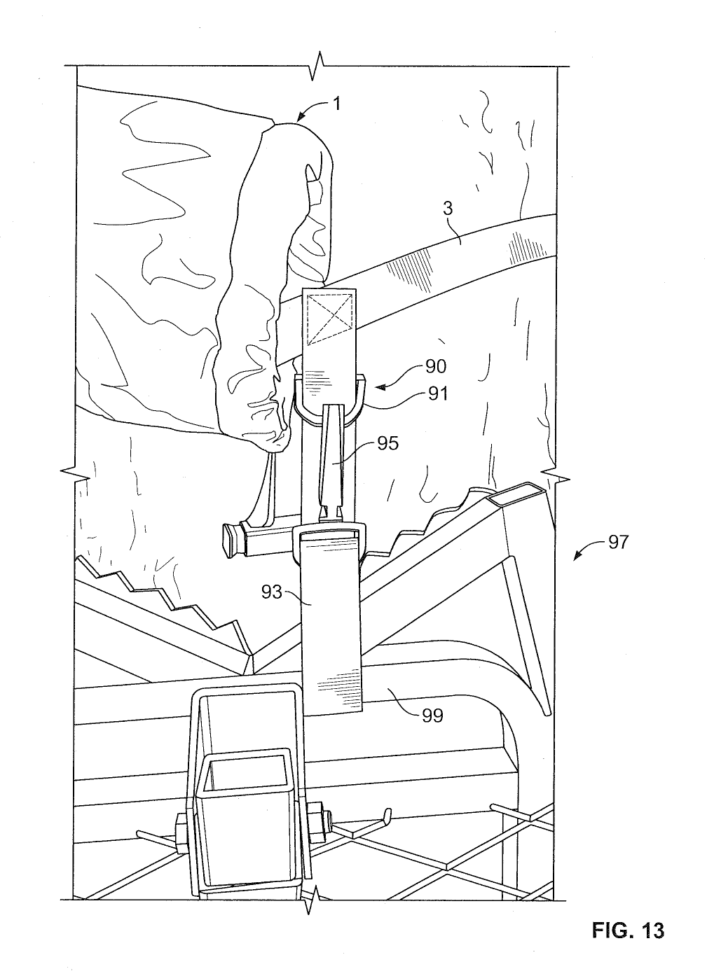

With reference to FIGS. 12 and 13, the treestand holding arrangement uses a connector designated by the reference 90. The connector 90 is designed to attach and hold a treestand once the clips 19 and 21 are attached together to hold the line 3 around a tree or the like. In this way, a person mounting or installing the treestand can use both hands for installation rather than using one hand for installation and the other hand to support the treestand during the installation process which is a safety enhancement to stand installation. While virtually any connector or means for attaching or supporting the treestand using the line 3 can be employed that would be held on one end to the line 3 and attach to a portion of a treestand to support its weight, one embodiment is depicted in FIG. 12 as having a d-ring 91 mounted on the line 3 and a length of line 93 with a clip 95 attached to the line 93. The clip 95 can be attach to the d-ring 91 once the line 93 is positioned with respect to a portion of a treestand so that it can be supported by the line 93 and attachment between the d-ring 91 and clip 95. The location of the device 90 should be so that it is between the bag 1 and the clip 21 so that once the line 3 is wrapped around a tree, the connector 90 is accessible for treestand support.

FIG. 13 shows an exemplary use of the device 90 holding a treestand 97, which is only partially depicted since showing the entire treestand is not necessary for understanding of the invention. The line 93 is shown looping around the treestand frame member 99 to provide support for the treestand for installation.

The treestand supporting arrangement can be used in combination with the bag 1 and line 3 without the shooting aid if so desired. The attachment of the connector 90 to the line 3 can be any type, threaded, riveted, combinations thereof or the like. Preferably, the connection is a fixed one so that the connector 90 does not move along the length of the line 3 and remains outside of the bag 1 and in a position making the treestand installation easy.

Again, the use of a d-ring, length of line, and clip are exemplary connectors and other connectors could be used. For example, the line 3 could just employ a large clip that would be big enough to attach to a frame member of the treestand. FIG. 15 illustrates another embodiment of the invention, wherein the bag 1 is used as a pocket or the like on a garment or other article like a backpack, fanny pack, or the like that a hunter would use. This embodiment is designated by the reference numeral 130 and shows a pocket 131 on a pair of pants 133. Only the leg portion 135 and a part of the waist of the pair of pants is shown since the other parts of the pants are well known. The pocket holds a length of line 137 with one end 139 of the line 137 attached to an outside of the pocket using a clip 141 and loop 143, which is similar to the attachments shown in earlier embodiments. This attachment can be any type that secures the end of the line for gear hoisting and encompasses the alternatives described above for the embodiment shown in FIG. 1 and others.

The other end of the line 137 is also secured inside the pocket at 145, either permanently stitched to the pocket or held in place with a clip 147 and loop 149, like the arrangement shown in FIG. 1 to secure the end 5 of the line 3. By using the pocket of the pants 133, there is no need for a separate bag 1 as shown in FIG. 1 and the bag becomes an integral part of the pants worn by the person using the line 137. While a pair of pants is illustrated with the pocket 101 for the line, any type of wearing apparel can be used to incorporate the bag therein for holding the line and keeping it tangle free, e.g., a pocket on a jacket, coat, shirt, or the like. Further, the pocket can be part of a fanny pack, backpack or other article that could be carried by the person intending to use the line 103.

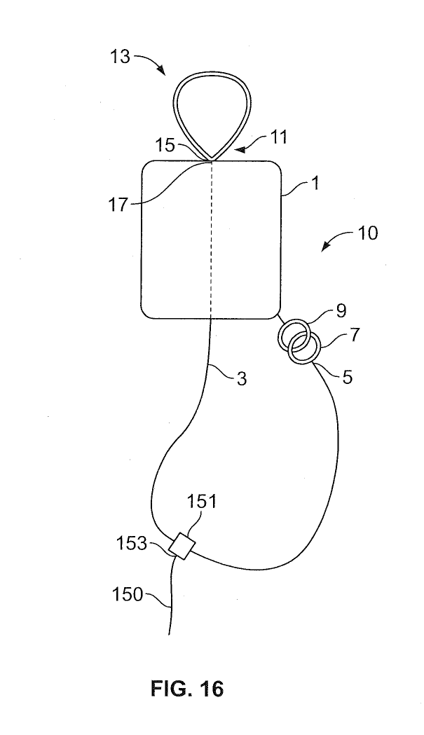

FIG. 16 shows the single line alternative to the shooting aid loop of FIG. 1. Instead of a loop, a single length of line 150 is used and movably attached at 151 using a buckle or any known device that would hold the line while allowing the end 153 to move along the length of the line 3. In this embodiment, a person using the shooting aid could either just hold the line 150 or wrap the line 150 around a body part to provide the support for aiming purposes or just hold the line 150, when the line is secured.

The invention also entails the method of hoisting gear using the line 3 once the bag is secured to an elevated structure like a tree. The free end 5 of the line 3 could be disconnected from the bag 1 and extended so that gear can be attached to the free end of the line and hoisted. The same method can be used if the bag is made part of a garment or other article for gear hoisting.

With the bag in place, the shooting aid loop is secure and can be used to support a shooter's arm during hunting.

The method further includes supporting a treestand once the bag is secured to the elevated structure so that the treestand can be easily installed.

As such, an invention has been disclosed in terms of preferred embodiments thereof which fulfills each and every one of the objects of the present invention as set forth above and provides a combination gear hoist and shooting aid and method of use.

Of course, various changes, modifications and alterations from the teachings of the present invention may be contemplated by those skilled in the art without departing from the intended spirit and scope thereof. It is intended that the present invention only be limited by the terms of the appended claims.

What is claimed is:

1. A hoist and shooting aid device comprising:
a container;
a length of line for storage in the container, the line having a free end and another portion of the line attached to the container;
means for attaching the free end of the line to the container;
means for attaching the container to an elevated structure; and
a shooting aid attached to the line, the shooting aid movable along a length of the line, the aid providing support for an arm or hand of a hunter for shooting when the container is attached to the elevated structure,
wherein the container is adapted to store the length of line in a tangle free state when the free end of the line is attached to the container.

2. The device of claim 1, wherein the means for attaching the container to the elevated structure further comprises a second length of line extending from the container and a connector, the connector connecting the second length of line extending from the container to a portion of the length of line intended to be stored in the container, the connection between the second length of line and the portion of the length of line forming a loop to encircle the elevated structure.

3. The device of claim 2, wherein the connector of claim 2 uses clips on the portion of the length of line and the second length of line.

4. The device of claim 1, wherein the shooting aid uses the length of line and an adjuster to control at least a position of the shooting aid with respect to the container.

5. The device of claim 1, wherein the shooting aid is separate from the length of line.

6. The device claim 1, wherein the means for attaching the free end of the length of line to the container is a clip on the free end and a loop on the container.

7. The device of claim 1, wherein the container has a drawstring for closing an opening of the container.

8. The device of claim 1, wherein the container is a flexible bag with an opening to access the length of line and a closing mechanism for the opening.

9. The device of claim 2, wherein the second length of line is either part of the length of line or separate therefrom.

10. The device of claim 1, wherein the means for attaching the bag is a loop extending from an outside of the bag.

11. The device of claim 10, wherein the loop is part of the length of line or is separate therefrom.

12. The device of claim 1, wherein the shooting aid is a loop or a shooting aid line having one end movably attached along the length of the line and another and opposite free end.

13. The device of claim 1, wherein the length of line includes a treestand connector, positioned on the line between the bag and the shooting aid, the connector configured to support a treestand prior to treestand installation.

14. In a method of hoisting gear to an elevated location using a bag containing a length of line stored therein, the improvement comprising using the device of claim 1 for gear hoisting.

15. The method of claim 13, further comprising providing support for an arm or hand of a hunter using the shooting aid.

16. A device for maintaining a length of line in a tangle free state comprising:
a container;
a length of line for storage in the container, the line having a free end and another portion of the line attached to the container;
means for attaching the free end of the line to the container;
wherein the container is adapted to store the length of line in a tangle free state when the free end of the line is attached to the container.

17. The device of claim 16, wherein the container is a pocket on a garment or a carrying article such as a backpack or fanny pack.

18. The device of claim 16, wherein the line is a length of rope, the rope detachable from the container for use separately therefrom.

19. The device of claim 16, wherein the line is an extension cord.
